(19) United States
(12) Patent Application Publication
(10) Pub. No.: US 2004/0141799 A1
(43) Pub. Date: Jul. 22, 2004

(54) Combination tooth paste and tooth brush

(76) Inventor: Richard Jackow, Coloina, NJ (US)

Correspondence Address: Mr. Walter J. Tencza Jr., Suite 3, 10 Station Place, Metuchen, NJ, 08840, US

(21) Appl. No.: 10/750,159

(22) Filed: Dec. 30, 2003

(51) Int. Cl. B43M 11/06; A46B 11/04; A47L 13/22

(52) U.S. Cl. 401/284; 401/291; 401/183

(57) ABSTRACT

A toothpaste container portion, which can be attached or detached from a toothbrush portion, is disclosed. The toothpaste container portion and the toothbrush portion can be screwed into one another to attach the two portions or can be unscrewed from each other to detach the two portions. The toothbrush portion may be comprised of a plurality of bristles. Each of the plurality of bristles may have a hollow interior through which toothpaste can flow. The toothpaste container portion may have a chamber. The toothbrush portion may have a chamber. Typically toothpaste can flow from the chamber of the toothpaste container into the chamber of the toothbrush portion.

### FIELD OF THE INVENTION

This invention relates to improved methods and apparatus concerning applying tooth paste.

### BACKGROUND OF THE INVENTION

Typically in the prior art an individual purchases a container of toothpaste and then applies the toothpaste to bristles of a separate toothbrush. The individual may then apply the toothpaste on the bristles to his or her teeth.

### SUMMARY OF THE INVENTION

The present invention in one or more embodiments provides an apparatus comprising a toothpaste container portion and a toothbrush portion. The toothpaste container portion typically can be attached or detached from the toothbrush portion. The toothpaste container portion and the toothbrush portion can be screwed into one another to attach the two portions or can be unscrewed from each other to detach the two portions.

The toothbrush portion may be comprised of a plurality of bristles. Each of the plurality of bristles may have a hollow interior through which toothpaste can flow. The toothpaste container portion may have a chamber. The toothbrush portion may have a chamber. Typically toothpaste can flow from the chamber of the toothpaste container into the chamber of the toothbrush portion.

The present invention, in one or more embodiments may also include a method comprising attaching a tooth paste container portion to a tooth brush portion, and detaching the tooth paste container portion from the tooth brush portion.

### BRIEF DESCRIPTION OF THE DRAWINGS

FIG. 1 shows a top view of an assembled apparatus in accordance with the present invention, which includes a toothpaste container portion and a toothbrush portion;

FIG. 2 shows a top view of the apparatus of FIG. 1 wherein the apparatus has been taken apart;

FIG. 3 shows a bottom view of the assembled apparatus of FIG. 1;

FIG. 4 shows a side view of the assembled apparatus of FIG. 1, with dashed lines used to show some internal portions of the apparatus of FIG. 1;

FIG. 5A shows a front view of the tooth brush portion of the apparatus of FIG. 1;

FIG. 5B shows a rear view of the toothpaste container portion of the apparatus of FIG. 1; and

FIG. 6 shows a top view of another embodiment of the present invention.

### DETAILED DESCRIPTION OF THE DRAWINGS

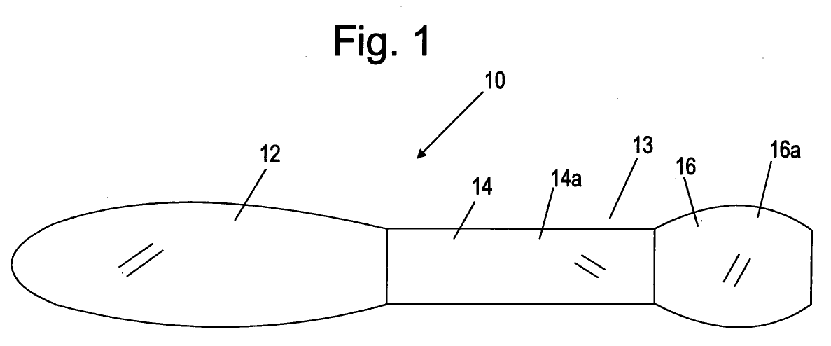

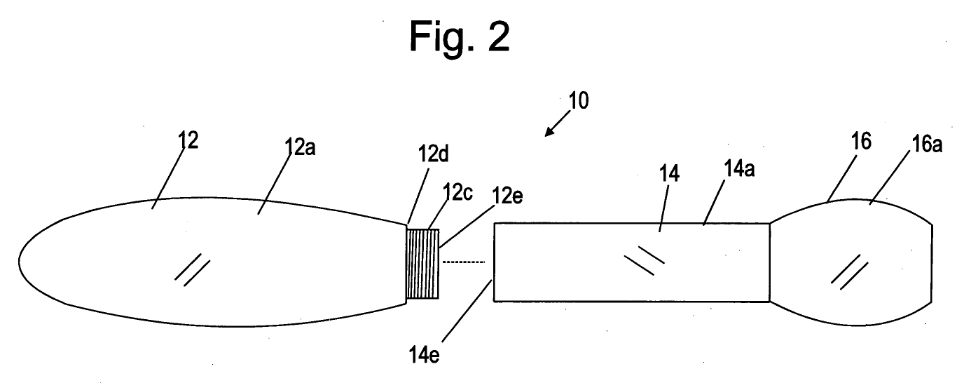

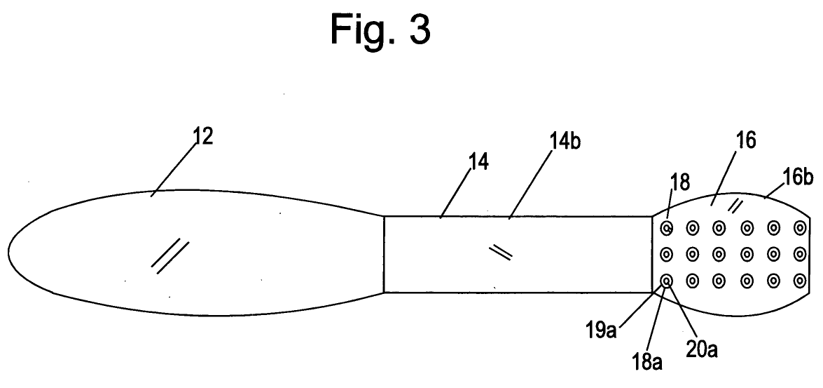

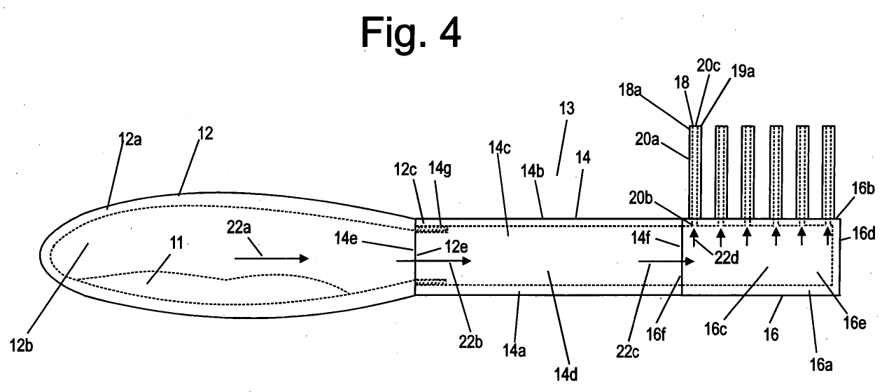

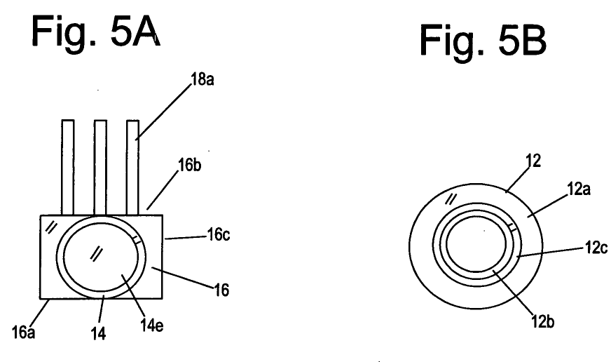

FIG. 1 shows a top view of an assembled apparatus 10 in accordance with the present invention, which includes a toothpaste container portion 12 and a toothbrush portion 13. FIG. 2 shows a top view of the apparatus 10 of FIG. 1 wherein the apparatus 10 has been taken apart. FIG. 3 shows a bottom view of the assembled apparatus 10 of FIG. 1. FIG. 4 shows a side view of the assembled apparatus 10 of FIG. 1, with dashed lines used to show some internal portions of the apparatus 10 of FIG. 1. FIG. 5A shows a front view of a tooth brush portion 13 of the apparatus 10 of FIG. 1. FIG. 5B shows a rear view of a toothpaste container portion 12 of the apparatus 10 of FIG. 1.

The toothpaste container portion 12 may be a container, which is sealed except for an opening 12e, shown in FIG. 2. The toothpaste container portion 12 may be comprised of flexible perimeter wall 12a and an inner chamber or cavity 12b in which tooth paste 11 may be located. The toothpaste container portion 12 may be connected by an externally threaded portion 12c to an internally threaded portion 14g of a portion 14 of the toothbrush portion 13. The toothbrush container portion 12 may have an edge 12d where the externally threaded portion 12c meets the remainder of the perimeter wall 12a.

The toothbrush portion 13 may be comprised of portions 14 and 16. Portion 14 may be a hollow tube with an opening 14e on one end and an opening 14f at an opposing end, as identified by FIG. 4. The portion 14 may include a top part 14a, a bottom part 14b, and a cavity or chamber 14d. Portion 16 may be integrally connected with portion 14. Portion 16 may include an opening 16f which is adjacent the opening 14f of the portion 14. Portion 16 may include top part 16a, bottom part 16b, rear 16d, and cavity 16e. The portion 16 may also include a plurality of attached bristles 18, such as bristle 18a. Each bristle of the bristles 18 may be similar to bristle 18a. Bristle 18a may be a hollow tube with an exterior portion 19a and a hollow interior 20a. An opening 20b may be located at one end of the hollow interior 20a and an opening 20c may be located at the other end of the hollow interior 20a.

In operation, the flexible perimeter wall 12a of the tooth paste container portion 12 can be squeezed to force tooth paste 11 located in a chamber or cavity 12b (within perimeter wall 12a and within tooth paste container 12 shown by dashed lines in FIG. 4) out of the chamber or cavity 12b, through the opening 12e, and into the portion 14 of the tooth brush portion 13. Toothpaste, such as toothpaste 11, shown by dashed lines in FIG. 4, may flow from inside the cavity 12b in the direction of arrows 22a and 22b, through opening 12e, into the opening 14e of the portion 14, and into the cavity 14d of the portion 14.

The tooth paste 11 may flow from tooth paste container portion 12 into portion 14, through portion 14, through opening 14f and into opening 16f of portion 16 of the tooth brush portion 13, as shown by arrow 22c. The toothpaste 11 will then be distributed through each of the plurality of bristles 18. For example, part of the toothpaste 11 will flow in the direction of arrow 22d into the hollow opening 20b of the bristle 18a, and into the hollow interior 20a. That part of the toothpaste 11 will flow through the hollow interior 20a and through the opening 20c so that it can be applied to an individual's tooth or teeth. Thereafter or during application of the toothpaste 11 to the individual's teeth, the bristles 18 can be used to brush the individual's teeth.

The toothpaste container portion 12 may also be called a handle. The toothpaste container portion 12 may connect or attach to the tooth brush portion 13 in a variety of ways.

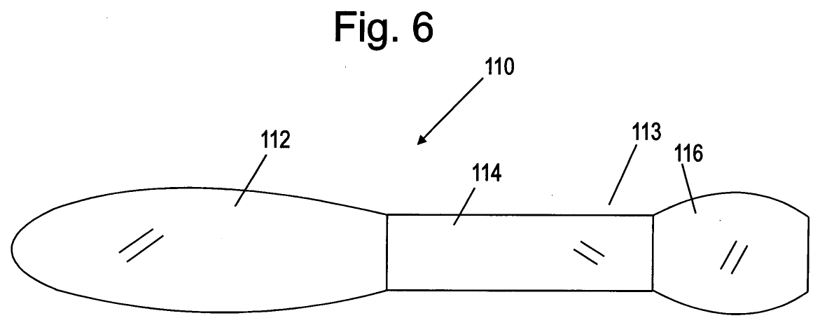

FIG. 6 shows a top view of another embodiment of the present invention. FIG. 6 shows a top view of an apparatus 110 which includes a toothpaste container portion 112 and a toothbrush portion 113. The apparatus 110 may be similar to the apparatus 10, with the exception that the toothpaste container portion 112 has been fixed to the toothbrush portion 113, typically at a manufacturing facility. In the embodiment shown in FIG. 6, the portion 112 is thus not detachable from the portion 113. The aparatus 110 includes a portion 114, and a portion 116 similar to portions 14 and 16 of the embodiment of FIG. 1. The apparatus 110 may be disposable.

A manufacturer may fill the portion 112 (which may be similar to the portion 12 of FIG. 1 except for not being made detachable) with toopaste and fix the portion 112 to the portion 113. The apparatus 110 may then be sold as a disposable unit. Toothpaste may flow from the portion 112 to the portion 113 similar to how it flows from the portion 12 to the portion 13 in the embodiment of FIG. 1.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a toothpaste container portion;
a tooth brush portion; and
wherein the toothpaste container portion is attached to the toothbrush portion.

2. The apparatus of claim 1 wherein
the toothpaste container portion can be detached from the toothbrush portion.

3. The apparatus of claim 2 wherein
the tooth paste container portion and the tooth brush portion can be screwed together to attach the tooth paste container portion to the tooth brush portion and can be unscrewed to detach the tooth paste container portion from the tooth brush portion.

4. The apparatus of claim 1 wherein
the tooth brush portion is comprised of a plurality of bristles; and
wherein each of the plurality of bristles has a hollow interior through which tooth paste can flow.

5. The apparatus of claim 1 wherein
the toothpaste container portion has a chamber;
the toothbrush portion has a chamber;
and wherein toothpaste can flow from the chamber of the toothpaste container into the chamber of the toothbrush portion.

6. The apparatus of claim 5 wherein
the tooth brush portion is comprised of a plurality of bristles; and
wherein each of the plurality of bristles has a hollow interior through which tooth paste can flow;
and wherein toothpaste can flow from the chamber of the toothbrush portion and into the hollow interior of each of the plurality of bristles.

7. The apparatus of claim 6 wherein
Toothpaste can flow from the hollow interior of each of the plurality of bristles out through an opening in each of the plurality of bristles and thereby out of the apparatus.

8. A method comprising:
attaching a toothpaste container portion to a toothbrush portion.

9. The method of claim 8 further comprising
detaching the toothpaste container portion from the toothbrush portion.

10. The method of claim 9 wherein
the tooth paste container portion and the tooth brush portion are screwed together to attach the tooth paste container portion to the tooth brush portion; and
the toothpaste container portion and the toothbrush portion are unscrewed from each other to detach the toothpaste container portion from the toothbrush portion.

11. The method of claim 8 wherein
the tooth brush portion is comprised of a plurality of bristles; and
wherein each of the plurality of bristles has a hollow interior through which tooth paste can flow.

12. The method of claim 8 wherein
the toothpaste container portion has a chamber;
the toothbrush portion has a chamber;
and wherein toothpaste can flow from the chamber of the toothpaste container into the chamber of the toothbrush portion.

13. The method of claim 12 wherein
the tooth brush portion is comprised of a plurality of bristles; and
wherein each of the plurality of bristles has a hollow interior through which tooth paste can flow;
and wherein toothpaste can flow from the chamber of the toothbrush portion and into the hollow interior of each of the plurality of bristles.

14. The method of claim 13 wherein
Toothpaste can flow from the hollow interior of each of the plurality of bristles out through an opening in each of the plurality of bristles.
